(19) United States
(12) Patent Application Publication
(10) Pub. No.: US 2014/0095713 A1
(43) Pub. Date: Apr. 3, 2014

(54) Predictive Vector-Based Transitioning of Mobile Wireless Devices

(71) Applicant: DIVX. LLC, Santa Clara, CA (US)

(72) Inventor: Ashleigh A. Miller, Denver, CO (US)

(73) Assignee: DIVX, LLC, Santa Clara, CA (US)

(21) Appl. No.: 13/632,109

(22) Filed: Sep. 30, 2012

(51) Int. Cl. H04W 36/08

(52) U.S. Cl. CPC H04W 36/08
USPC 709/225

(57) ABSTRACT

Predictive vector-based addressing to provide uninterrupted packet-based content to a wireless device as the wireless device roams within a network. A static channel is established between the network and a content provider based on credentials of the wireless device. Content is received from the content provider over the static channel, buffered, and provided to the wireless device through a first wireless access point (AP). A motion trajectory is estimated for the wireless device, and one or more destination APs are predicted for the wireless device based on a combination of the motion trajectory, geographic location of network APs, and one or more travel constraints. Identical buffered content is provided to the wireless device through the first AP and the one or more predicted destination APs during a transition period, synchronous with one another. The static channel is maintained with the content provider during the transition period.

### BACKGROUND

A mobile wireless device may establish an Internet protocol (IP) based communication session with a content provider through a public or private wireless network presence (i.e., hot spot), to receive content from the content provider. The content may include streaming content, such as streaming media.

When a mobile wireless device moves out of range of a first hot spot, the device may seek an available second hot spot, typically based on signal strength of the second hot spot. The device must initiate a handover or hand-off procedure with the second hot spot in order to transition to the second hot spot. The device may also have to re-establish a session with a content provider through the second hot spot.

Conventional handover procedures are relatively complex, and may result in delayed or dropped packets, which may be especially noticeable when the content includes streaming media.

### SUMMARY

Disclosed herein are predictive vector-based techniques to provide seamless uninterrupted packet-based content from a content provider to a mobile wireless device as the mobile wireless device roams within a packet-based network.

A first wireless channel or session is established between a mobile wireless device (wireless device) and a first wireless access point or point-of-presence (AP/POP).

A static channel or session is established between the network and a content provider based on credentials of the wireless device, to receive packet-based content from the content provider. The content may include streaming content, such as streaming media.

The content is received by the network over the static channel and provided from the network to the wireless device over the first wireless channel independent of one another. The content may be buffered by the network, and status of consumption or receipt by the wireless device may be tracked.

A motion trajectory or motion vector is determined based on prior locations of the wireless device and corresponding time-stamps.

One or more other APs/POPs are predicted as destination APs/POPs to which the wireless device will roam based on the motion vector, locations of the APs/POPs, and one or more travel constraints.

A travel constraint may include, without limitation, a road map, speed limit(s), traffic conditions, and/or information associated with the wireless device such a prior travel routes of the wireless device.

The wireless device may be transitioned to a predicted destination AP/POP (second AP/POP), at a time or packet at which the wireless device is predicted to be within overlapping wireless coverage areas of the first and second APs/POPs.

Substantially identical content may be provided synchronously over the first and second wireless channels during a transition period to avoid interruption or disruption of the content provided to the wireless device.

The static channel with the content provider is maintained during the transition and thereafter to preclude interruption of the content from the content provider.

A predicted destination AP/POP may be provided with advance notification and information (e.g., device credentials), to prepare for a transition.

Predictive vector-based addressing, as disclosed herein, permits hot-swapping of a wireless device amongst wireless APs, in which a wireless device roams or transitions between APs/POPs without interruption of a static channel/session to a content provider (i.e., without handshaking or negotiation of the static channel or session), and without interruption of content provided to the wireless device.

### BRIEF DESCRIPTION OF THE DRAWINGS

FIG. 1 is a depiction of a network to provide seamless, uninterrupted packet-based content to a mobile wireless device as the wireless device roams within the network.

FIG. 2 is a flowchart of a method of providing seamless, uninterrupted packet-based content to a wireless device as the wireless device roams within a network.

FIG. 3 is a depiction of a wireless device within a wireless coverage area of a wireless access point and/or point-of-presence (AP/POP), to receive content over a wireless channel.

FIG. 4 is a depiction of another network to provide seamless, uninterrupted packet-based content to a wireless device as the wireless device roams within the network.

FIG. 5 is a depiction of another network, including a wireless device to maintain seamless packet-based content to a user-interface during transitions amongst APs/POPs.

FIG. 6 is a block diagram of a computer system configured as a network management computer system to manage a packet-based network infrastructure.

FIG. 7 is a block diagram of a computer system configured as a content tracking system of a mobile wireless device to provide seamless packet-based content to a user-interface of the mobile wireless device during transitions amongst APs/POPs.

In the drawings, the leftmost digit(s) of a reference number identifies the drawing in which the reference number first appears.

### DETAILED DESCRIPTION

As used herein, the term “packet protocol” (PP) refers to a communication protocol to relay datagrams or network packets in a communication network, such as the Internet or other network. A PP protocol may include an Internet protocol suite based on a transmission control protocol (TCP) and an Internet protocol (IP), or TCP/IP. A packet protocol is not, however, limited to TCP, IP or TCP/IP protocols.

As used herein, the term “PP device” refers to device or system configured to communicate using a PP.

As used herein, the term “PP channel” refers to a communication channel over which devices communicate based on a PP.

As used herein, the term “PP session” refers to a communication session over a PP channel.

As used herein, the term “PP network” refers to a network of PP systems and/or devices to communicate over PP channels, which may include configurable routing.

As used herein, the term “point-of-presence” (POP) may refer to a wireless access point (AP) or a combination of an AP and a corresponding router, depending on context.

Unless specified otherwise herein, a reference to a network, a channel, or a session refers to a PP network, PP channel, or PP session, respectively.

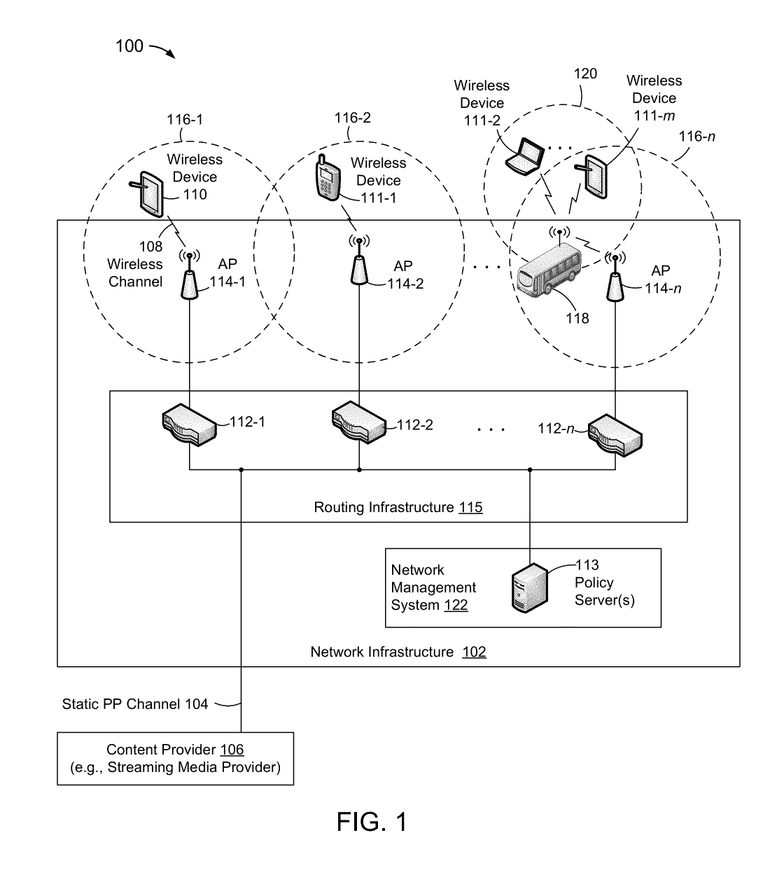

FIG. 1 is a depiction of a network environment 100 to provide seamless, uninterrupted packet-based content to a mobile wireless devices (wireless device) as the wireless device roams wireless coverage areas of network environment 100.

Network environment 100 includes network infrastructure 102, including routing infrastructure 115 to route packets within network environment 100. Routing infrastructure 115 essentially defines configurable communication channels within network environment 100.

Network infrastructure 102 further includes wireless access points APs or POPs (APs/POPs) 114 to communicate with wireless devices 110 and 111. In the example of FIG. 1, network infrastructure 102 further includes a mobile wireless AP/POP 118, hosted by AP/POP 114-n, to communicate with wireless devices 111-2 through 111-m. A router 112 may support one or more APs/POPs.

APs/POPs 114 and 118 may each support multiple wireless devices within corresponding wireless coverage areas 116 and 120.

A router 112 and associated AP(s) 114 may represent a wireless local area network (WLAN), and network infrastructure 102 may represent a wide area network (WAN).

Network environment 100 further includes a network management system 122 to manage network infrastructure 102.

For illustrative purposes, examples are provided below with reference to wireless device 110.

FIG. 1 depicts a wireless channel 108 between wireless device 110 and AP 114-1, and a channel 104 to a content provider 106. Channel 104 may be a static channel for which packet protocol addresses are static or fixed.

Channels 108 and 104 host corresponding first and second sessions, substantially parallel in time with one another, to provide content to wireless device 110 substantially as it is received from a content provider 106.

Network infrastructure 102 and network management system 122 are configured to transition wireless device 110 to other APs 114, 118, without interruption of the second session over channel 104, without interruption of content provided to wireless device 110, and without interruption in presentation of the content at wireless device 110.

Network management system 122 may predict one or more POPs as a potential roaming destination of a wireless device, and may initiate a transition of the wireless device to the predicted POP(s).

A roaming prediction may be based on combination of a motion trajectory or vector of wireless device 110, locations of APs 114, and one or more travel constraints that may impact motion or travel of wireless device 110 relative to one or more of APs 114.

The motion trajectory may include current location, direction and/or speed of wireless device 110, and may be formatted as a motion vector having a tail corresponding to a current location of wireless device 110.

The current location, speed, and/or direction of wireless device 110 may be received from wireless device 110 and/or computed or estimated from other information received from or otherwise associated with device 110.

The current location, speed, and/or direction of wireless device 110 may be based at least in part on global positioning system (GPS) position coordinates provided by wireless device 110.

The current location, direction, and/or speed of wireless device 110 may be at least in part on historical location information and corresponding time-stamps associated with wireless device 110. Historical location information may include prior GPS location coordinates received of wireless device 110 and/or locations of POPs with which wireless device 110 previously communicated.

The current location, direction, and/or speed of wireless device 110 may be at least in part on strengths of wireless signals received by wireless device 110 from one or more AP/POPs 114, and reported by wireless device 110.

The current location, direction, and/or speed of wireless device 110 may be at least in part on strengths of a wireless signal received from wireless device 110 by one or more AP/POPs 114, and reported by the corresponding AP/POPs 114.

The current location, direction, and/or speed of wireless device 110 may be at least in part on estimations based on a measure of responsiveness of one or more AP/POPs 114 with respect to wireless device 110.

A travel constraint may include a geographic travel constraint, such as a permitted travel route(s), which may be based on a road map and which may include current detours.

A travel constraint may include a time-based travel constraint, such as a posted speed limit and/or estimated time-delays due to traffic conditions (e.g., volume, congestion, and/or construction).

A travel constraint may include a constraint associated with wireless device 110, such as a prior route(s) and/or other information associated with the wireless device.

Network management system 122 may initiate a transition of wireless device 110 to a predicted AP, such as AP 114-2.

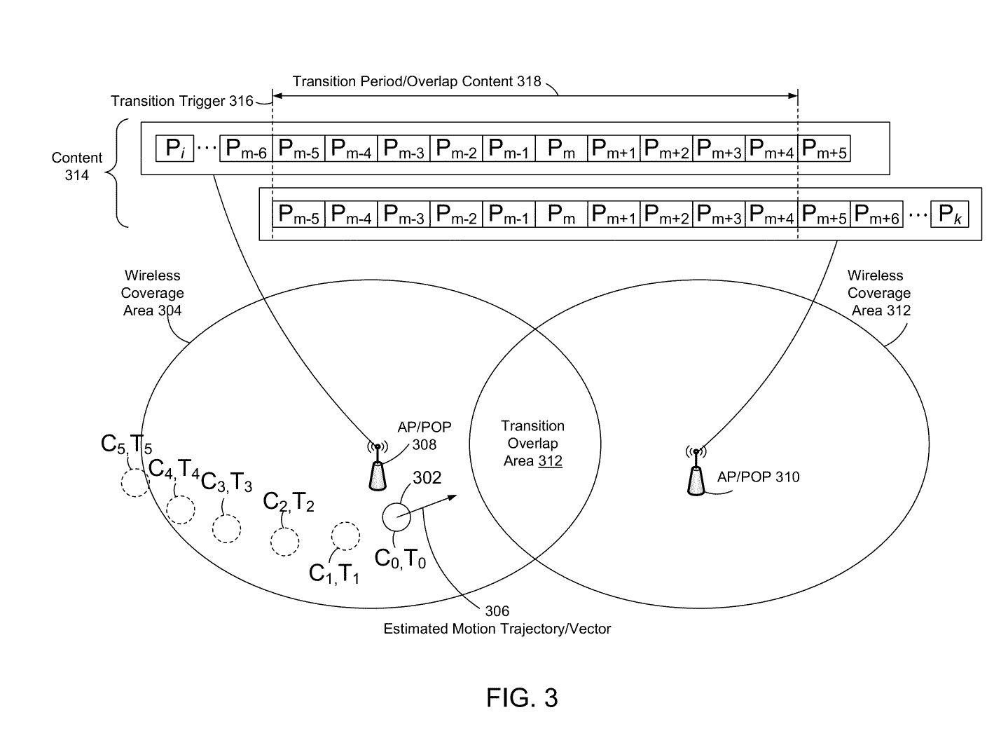

During the transition, substantially identical, synchronized content may be provided to wireless APs 114-1 and 114-2, such as described further below with reference to FIG. 3.

Network management system 122 may be provided with information to be “aware” of sessions with wireless devices and/or content providers. The information may include, without limitation, device credentials, wireless device session information, time-stamps in combination with wireless device location information (e.g., GPS data), geographical locations of APs/POPs, and/or AP/POP history of wireless devices.

Device credentials may include a device identifier (ID), content source address, and/or account information such as a login ID and password. Device IDs are described further below.

Network management system 122 may isolate addresses or device IDs of wireless devices, and/or may perform one or more verification procedures and/or manage wireless devices based on the addresses or unique IDs to avoid device conflicts.

Network management system 122 may monitor and/or manage policies, device credentials, and/or streaming content status, and may convey policies, device credentials, and/or streaming content status to predicted APs/POPs and/or wireless devices prior to transitions.

Network management system 122 may include and/or be implemented as one or more policy servers 113, and may be implemented in a centralized fashion, a distributed fashion, or a combination thereof. For example, routers 112 and/or POPs may each include a policy server to manage transitions from to other routers 112 and/or POPs.

Device IDs are now described.

A device ID may be analogous to an IP address of a conventional IP network, where each IP address may support a finite number of additional devices based on subnet masks and gateways.

Alternatively, device-specific information associated with a mobile device may be used to generate a network-unique device ID to communicate with the mobile device throughout network environment 100. Network interface system 122 may track device-specific information to avoid device conflicts across network environment 100.

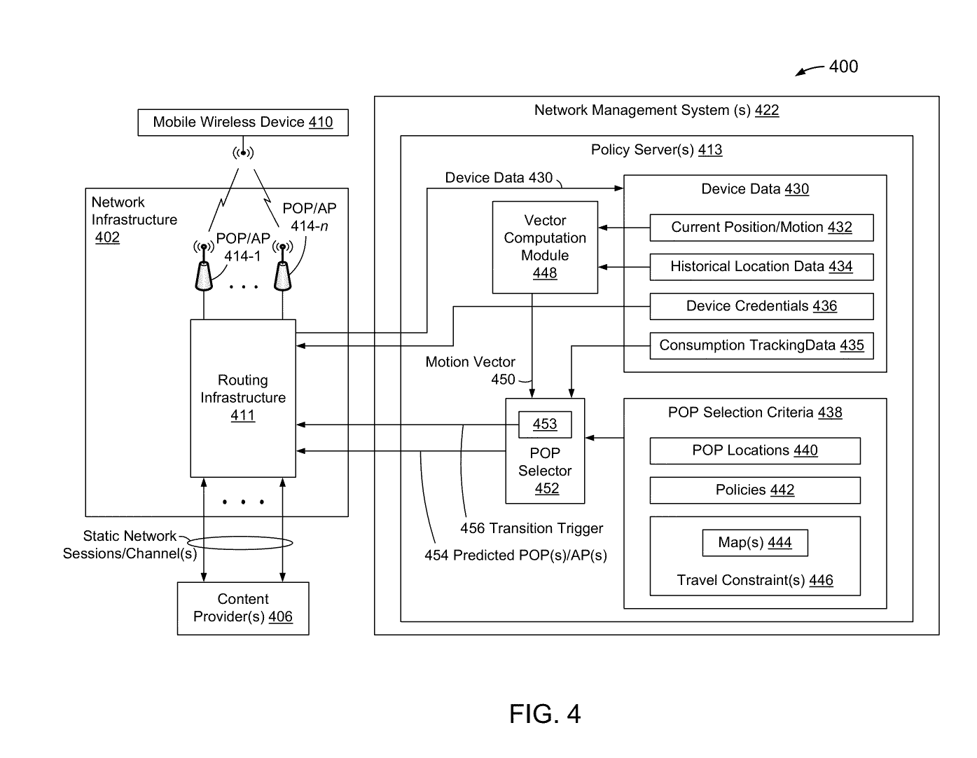

Device specific information may include, for example, device ID/IP pairing and/or medium access controller (MAC) address, and the network-unique device ID may be referred to as an expanded PP address. Device IDs may be maintained, tracked, and/or propagated by a policy server, such as policy server 113 in FIG. 1 and/or a policy server 413 in FIG. 4, discussed further below.

Network-unique device IDs may be encrypted to protect wireless devices from exposure network environment 100.

Network-unique device IDs may help avoid device conflicts and/or initialization delays with respect to streaming content during transitions of mobile devices amongst POPs of network environment 100.

Network-unique device IDs may be registered and/or propagated throughout network environment 100 to avoid duplicate wireless devices. Network-unique device IDs and data may be transferred relatively quickly amongst POPs of network environment 100.

Sessions and mobile devices may be updated in accordance with an address resolution protocol (ARP), such as in an ARP-like virtual table, which may be communicated to policy servers 113.

Network-unique device IDs, such as expanded IP addresses, may expedite and simplify initialization of sessions with content providers.

Network-unique device IDs may be managed via policy servers 113. Policy servers 113 may permit tracking of information associated with corresponding mobile devices, such as connection history, home POP, and/or vector information.

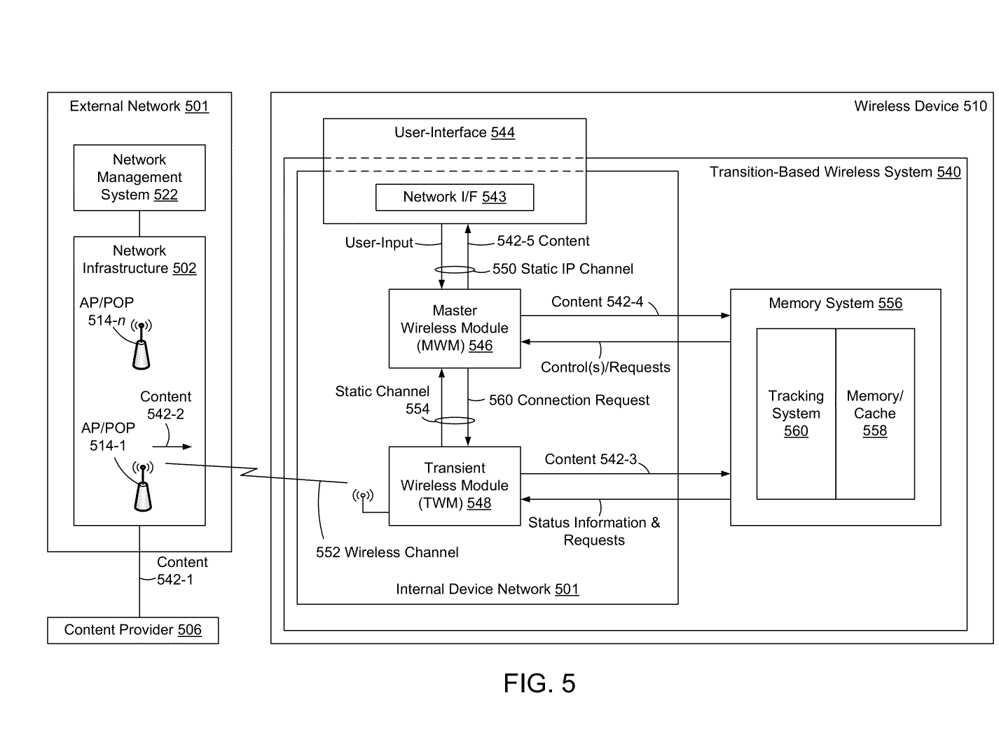

An example configuration of a network management system is presented further below with reference to FIG. 4. An example configuration of a wireless device is presented below with reference to FIG. 5.

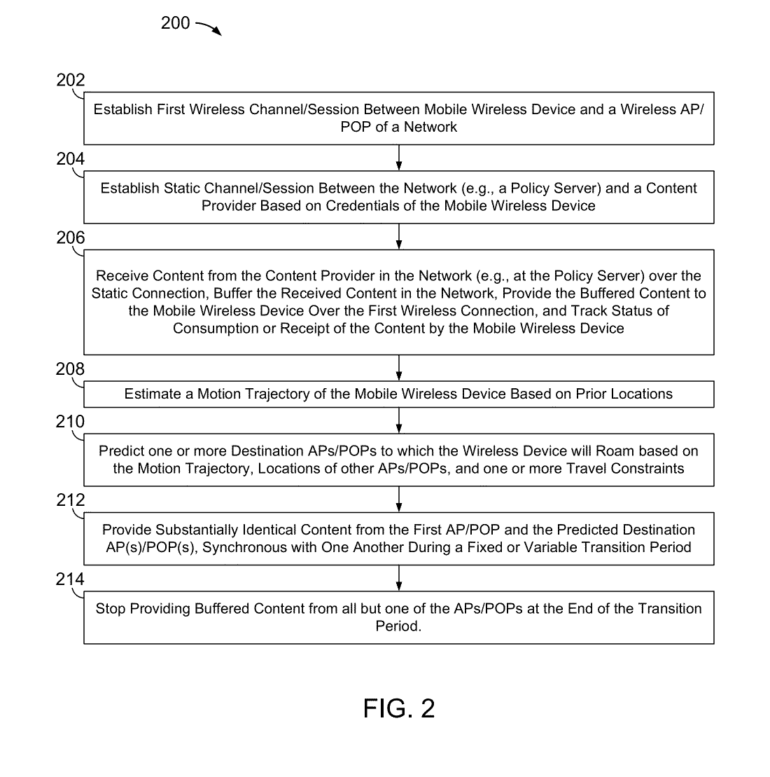

FIG. 2 is a flowchart of a method 200 of providing seamless, uninterrupted packet-based content to a wireless device as the wireless device roams within a network. Method 200 is described below with reference to network environment 100 of FIG. 1. Method 200 is not, however, limited to the example of FIG. 1.

At 202, a first wireless connection, such as wireless connection 108 in FIG. 1, is negotiated between mobile wireless device 110 and network infrastructure 102 (e.g., policy server 113) through a first AP 114-1 and/or POP (first AP/POP 114-1) of network infrastructure 102. The negotiation may include a handshake procedure between wireless device 110 and policy server 113 through first AP/POP 114. Wireless device 110 may provide device credentials. Wireless device 110 and/or the device credentials may be verified or authenticated by policy server 113.

As described further below, wireless device 110 may roam to a second AP/POP of network environment 100 without having to re-negotiate a connection with the second AP/POP. Rather, a handshake-like procedure may be initiated from an AP/POP with existing session information.

At 204, static channel 104 is established or negotiated between the network infrastructure (e.g., policy server 113), and content provider 106 based on credentials of the mobile wireless device.

Static channel 104 may be initiated in response to a request from wireless device 110 over first wireless channel 108. The initiation of static channel 104 may include negotiation of a handshake procedure between policy server 113 and content provider 106.

As described further below, policy server 113 may continue receiving content from content provider 106 over static channel 114 during and subsequent to a transition of wireless device 110 from first AP/POP 114-1 to a second AP/POP. Specifically, policy server 113 may maintain static channel 114 during and subsequent to the transition based on the device credentials of wireless device 110, without having to re-negotiate a channel or perform a handshake procedure with content provider 106.

At 206, content is received by network (e.g., at the policy server) from content provider 106 over the static channel, buffered, and provided to mobile wireless device 110 over first wireless channel 108 through first AP/POP 114-1. Status of consumption by the wireless device may be tracked by policy server 113, and may be used by policy server 113 to select a point at which to initiate a transition of wireless device 110 to one or more other APs/POPs as described further below.

At 208, a motion trajectory is estimated for wireless device 110, such as described above with reference to FIG. 1.

At 210, one or more destination APs/POPs 114 are predicted as potential roaming destinations of wireless device 110 based on the motion trajectory, locations of the destination AP(s)/POP(s), and one or more travel constraints.

The prediction may include predicting a time and/or a position within the content at which wireless device 110 will be within overlapping wireless coverage areas of first AP/POP 114-1 and the destination AP(s)/POP(s). A predicted time and/or position within the content may be determined by policy server 113 based on consumption or receipt of content by mobile device 110, which may be tracked by policy server 113.

The predicting at 208 may include computing a transition trigger to indicate a beginning or start of a transition period based on predicted time and/or position. The transition trigger may be determined as a time-to-live and/or a packet ID.

At 212, first AP/POP 114 and the predicted destination AP(s)/POP(s) 114 transmit substantially identical buffered content, synchronous with one another, during a transition period. The transition period may begin at the transition trigger.

At 214, first AP/POP 114 and the predicted destination AP(s)/POP(s) 114 continue transmitting substantially identical synchronous buffered content over a transition period, which may be fixed or variable.

A fixed transition period may be useful, for example, where there is a relatively high degree of confidence that wireless device 110 will roam to a particular destination AP/POP at a predicted time and/or position within the content. A high degree of confidence may occur where the motion trajectory for wireless device 110 remains relatively constant over a relatively extended period of time, where there are relatively few APs/POPs to choose from, and/or where there is only one predicted destination AP/POP.

A variable transition period may be useful where multiple APs/POPs are predicted as potential destinations of wireless device 110, and/or where there is a lower degree of confidence in a destination prediction. A lower degree of confidence may occur where the motion trajectory for wireless device 110 changes relatively frequently and/or relatively abruptly, such as where wireless device travels in an urban environment.

In the case of a fixed transition period, first AP/POP 114-1 stops transmitting the buffered content at the end of the transition period.

In the case of a variable transition period, first AP/POP 114-1 and the destination AP(s)/POP(s) continue transmitting the buffered content until one of the APs/POPs is selected as an appropriate AP/POP for wireless device 110. The selection may be based on an updated motion trajectory for wireless device 110, signal strengths as described above, and/or responsiveness of the APs/POPs as described above. Upon selection of one of the APs/POPs, the other AP(s)/POP(s) stop transmitting the buffered content.

As described further below, wireless device 110 may be configured receive content from a combination of predicted destination APs/POPs, and/or from a combination of first AP/POP 114-1 and one or more predicted destination APs/POPs, during the transition period. Wireless device 110 may be further configured to discard content received from one or more of the APs/POPs when the content is identical to content received from another one of the APs/POPs. For example, wireless device 110 may be configured to discard content received from first AP/POP 114-1 when wireless device 110 received the same content from a predicted destination AP/POP 114. Discarding of redundant content may help to conserve memory in wireless device 110.

FIG. 3 is a depiction of a wireless device 302 within a wireless coverage area 304 of a wireless AP/POP 308, to receive content 314 over a wireless channel.

Content 314 may include streaming content, such as streaming media (e.g., streaming audio and/or video). Content 314 includes content Pᵢ through Pₖ, each of which may represent one or more packets or frames.

FIG. 3 further depicts position coordinates C₅ through C₀ of wireless device 302, and corresponding time-stamps T₅ through T₀. Coordinates C₀ may represent a most-recent and/or current position of wireless device 302.

FIG. 3 further depicts a motion trajectory or vector 306 of wireless device 302. An orientation of vector 306 corresponds to a computed or estimated direction of wireless device 302. A length of vector 306 represents a computed or estimated speed of wireless device 302. A tail of vector 306 is associated with coordinates C₀.

Vector 306 may be computed or estimated based on one or more of:
coordinates C₅ through C₀ and corresponding time-stamps T₅ through T₀;
locations of prior APs/POPs with which wireless device 302 previously communicated; and
other information associated with wireless device 302, such as signal strengths and/or responsiveness as described further above.

A GPS may provide relatively accurate and precise position coordinates of wireless device 302 at particular instances in time. Speed and direction of wireless device 302 may thus be determined relatively accurately for time frames between sets of GPS coordinates. The computed speed and/or direction may be averaged, projected, and/or otherwise processed to predict future speed and/or direction.

Similarly, locations of prior APs/POPs and corresponding time-stamps may be used to compute speed and/or direction of wireless device 302 between the POPs. The computed speed and/or direction may be averaged, projected, and/or otherwise processed to predict vector 306.

Locations of prior POPs may represent approximate locations of wireless device 302, over a relatively long period of time during which wireless device 302 traveled within range of the prior APs/POPs. The approximate locations over a relative long period of time may provide relatively accurate average values for speed and direction of wireless device 302 over the period of time, which may be useful alone and/or in combination with GPS locations of wireless device 302, such as in an example below.

To conserve memory requirements, older GPS coordinates of wireless device 302 may be discarded based on threshold number of stored coordinates and/or age. In some situations, a motion trajectory based on a limited set of most-recent GPS coordinates may accurately reflect future direction and/or speed of wireless device 302. This may not be so in all situations.

For example, wireless device 302 may travel for an extended time and/or distance over a roadway in a general overall direction (e.g., north, south, east, west). When the most-recent GPS coordinates of wireless device 302 are obtained while wireless device 302 is on the first roadway, motion vector computed from the most-recent GPS coordinates may accurately reflect future direction and/or speed of wireless device 302.

At some point, wireless device 302 may temporarily exit the roadway, such as for food or rest. This may involve a number of frequent turns, starts and stops, and/or lower maximum speed relative to the roadway. Where the most-recent GPS coordinates are obtained during the food or rest stop, the GPS coordinates may not represent future direction and/or speed of wireless device 302 sufficiently accurately, which may impact accuracy or reliability of vector 306.

During the extended trip, however, a list of prior POPs will predominantly include POPs along the roadway, which will likely provide a sufficiently accurate estimate of future direction and/or speed of wireless device 302.

Vector 306 is used to predict one or more potential destination AP(s)/POP(s) of wireless device 302, such as described above with reference to 210 in FIG. 2.

In some situations, a destination POP may be predicted based solely or predominantly on vector 306 and locations of other POPs. In FIG. 3, for example, vector 306 is directed towards a coverage area 312 of an AP/POP 310, indicating that AP/POP 310 may be an appropriate predicted destination of wireless device 302. In other situations, however, vector 306 may indicate multiple potential destination APs/POPs for mobile device 302. In addition, one or more travel constraints may, however, impact future direction and/or speed of wireless device 302, in a way that may not be predictable from vector 306. Vector 306 may thus be evaluated further with respect to one or more travel constraints that apply to wireless device 302.

Where AP/POP 310 is predicted as a destination of wireless device 302, a transition trigger 316 may be computed to indicate a time or packet within content 314 at which to initiate transition of wireless device 302 to AP/POP 310, such as described above with reference to 210 in FIG. 2. Transition trigger 316 may be based on a prediction as to when wireless device 302 will be within overlapping portions of areas 304 and 308, referred to herein as a transition overlap area 312. Transition trigger 316 may be determined based in part of buffered content consumed or received by wireless device 302, which may be tracked by a policy server such as described in one or more examples herein.

Prior to transition trigger 316, content Pᵢ through Pₘ₋₆ is provided to wireless device 302 through AP/POP 308.

At transition trigger 316, predicted destination AP(s)/POP(s), such as AP/POP 310, begin transmitting substantially identical buffered content, synchronous with buffered content transmitted from AP/POP 308.

AP/POP 308, AP/POP 310, and any other predicted destination AP(s)/POP(s) continue transmitting substantially identical, synchronous buffered content for a transition period, which may be fixed or variable as described further above.

In the example of FIG. 3, content Pₘ₋₅ through Pₘ₊₄ is transmitted by AP/POP 308, AP/POP 310, and any other predicted destination AP(s)/POP(s), synchronous with one another, during a transition period 318.

Also in FIG. 3, AP/POP 310 continues to provide buffered content subsequent to transition period 318, whereas AP/POP 308 and any other predicted destination AP(s)/POP(s), stop providing buffered content at the end of transition period 318.

In the example of FIG. 3, ten overlapping packets or frames are transmitted from APs/POPs 308 and 310. Methods and systems disclosed herein are not limited to this example.

FIG. 4 is a depiction of a network environment 400, including an example implementation of a policy server 413, to provide substantially seamless uninterrupted packet-based content to a wireless device as the wireless device roams within network environment 400.

Network environment 400 includes network infrastructure 402, which may be implemented as described above with reference to FIG. 1.

Network environment 400 further includes a network management system 422, illustrated here as including policy server 413. Policy server 413 may service all of network infrastructure 410 or a portion thereof. Each AP/POP 414 may, for example, include a corresponding policy server 413.

Policy server 413 includes device data 430, which may include information provided by wireless device 410 through AP/POP 414-1, and/or information provided by one or more other APs/POPs 414 and/or from routing infrastructure 411. Device data 430 may include current position and/or motion data 432, historical location data 434 (e.g., prior APs/POPs), time-stamps, device credentials 436, consumption tracking data 435, and/or other data associated with a wireless device 410, such as described in one or more examples herein.

Policy server 413 further includes POP selection criteria 438, which may be provided by an administrator account or server and/or retrieved from other source(s) by policy server 413.

POP selection criteria 438 may include AP/POP geographic position data 440, policies 442, and/or travel constraints 446, which may include road maps 444, such as described in one or more examples herein.

Policy server 413 further includes a computation module 448 to compute an estimated motion trajectory or motion vector 450 of wireless device 410 based on a combination of current position and/or motion data 432, historical location data 434, and corresponding time-stamps, such as described in one or more examples herein.

Policy server 413 further includes a POP selector 452 to predict one or more other APs/POPs 114 as potential or most-likely destination AP(s)/POP(s) of mobile device 410, and to provide a corresponding indication 454 of the predicted AP(s)/POP(s).

POP selector 452 further includes a trigger generator 453 to compute a transition trigger 456 to initiate a transition procedure with respect to mobile device 410 and the predicted AP(s)/POP(s), such as described in one or more examples herein. Transition trigger 456 may be computed based in part on consumption tracking data 435.

FIG. 5 is block diagram of a network environment 500, including a wireless device 510 having a transition-based wireless system 540 to host an internal packet-based network 501, to seamlessly transition amongst wireless APs/POPs 514 of an external packet-based network 501 and to provide seamless content 542 from external network 501 to a wireless device user-interface 544 during the transitions.

For illustrative purposes, content 542 is denoted in FIG. 5 as content 542-1 through 542-5 to distinguish amongst references to content 542 at various points of a content path.

Network 501 includes network infrastructure 502 and a network management system 522 to receive content 542-1 from a content provider 506, and to provide corresponding content 542-2 to wireless device 510 through one or more APs/POPs 514. Network infrastructure 502 and a network management system 522 may be implemented as described in one or more examples herein. Network infrastructure 502 and network management system 522 are not, however, limited to examples above.

Transition-based wireless system 540 includes a master wireless module (MWM) 546 and a transient wireless module (TWM) 548, to provide corresponding first and second wireless presences of internal device network 501.

MWM 546 provides a static channel 550 to communicate with a user-interface 544 through a network interface 543. User-interface 544 may include display, an audio device, and/or a processor to process or prepare content 542-5 for the display and/or audio device.

TWM 548 provides a wireless channel 552 with an AP/POP 514-1 to receive content 542-2 from external network 501.

Transition-based wireless system 540 further includes a fixed static channel 554 to permit communication between TWM 548 and MWM 546. Static channel 544 may be configured in hardware.

MWM 546, TWM 548, static channel 544 may be implemented on a same circuit card.

MWM 546 and TWM 548 may be “intelligent” in the sense that they may be provided with information regarding connection status of wireless device 510 and/or content provider 506, and may receive content consumption tracking information or streaming progress.

Wireless device 510 may be associated with an identifier (ID), such as described further above. TWM 548 and AP/POP 514-1 communicate with one another over wireless channel 552 based on the ID of wireless device 510 and an address of AP/POP 514-1.

Transition-based wireless system 540 further includes a memory system 556 to buffer content 542-3 from TWM 548, and to provide buffered content 542-4 to MWM 546. Memory system 556 includes memory or cache 558 to buffer content 542-3, and a content tracking system 560 to manage cache 558. Cache 558 may be controllable to buffer content 542-3 similar to pipeline cache or random access memory (RAM), and may be controllable to provide buffered content 542-4 to MWM 546 in a first-in first-out (FIFO) manner.

TWM 548 transfers content 542-2 to memory system 556 as content 542-3. TWM 548 may write content 542-3 directly to cache 558, or indirectly through tracking system 560. TWM 548 may also manage wireless connectivity with network infrastructure 522.

MWM 546 manages a rate at which buffered content 542-5 is provided from cache 558 to user-interface 544. MWM 546 may read buffered content 542-4 directly from cache 558, or indirectly through tracking system 560.

Tracking system 560 monitors and/or manages cache 558, and tracks packet order, progress of incoming content 542-3, and progress of outgoing buffered content 542-4. Tracking system 560 may also track overall network connection.

Cache 558 may be managed to ensure a seamless or continuous uninterrupted stream of content 542-5 to user-interface 544, including during a transition of wireless device 510 to another AP/POP 514.

Memory system 556 may manage device credentials of wireless device 510, which may include certificate-based credentials

An example is provided below with respect to wireless device 510.

When user-interface 544 first connects to MWM 546 through network interface 543, MWM 546 sends a connection request 560 to TWM 548. TWM 548 then initiates a wireless session with AP/POP 514-1 over wireless channel 552 based on the ID of wireless device 510 and the addresses of AP/POP 514-1.

After establishing the wireless session, tracking system 560 monitors a pace or data rate of incoming content 542-3 and outgoing buffered content 542-4. Tracking system 560 may also monitor an amount of content 542-3 buffered in cache 558. Tracking system 560 and/or TWM 548 may generate a request to increase or decrease a transmission rate of content 542-2 based on the monitoring to avoid buffer exhaustion and buffer overflow.

The data rate of incoming content 542-3 and/or of outgoing buffered content 542-4 may be managed to ensure that sufficient content 542-3 is buffered prior to a transition so that MWM 546 can provide streaming content 542-5 throughout the transition without exhausting cache 558. Cache 558 may also be managed to avoid buffer overflow.

A request to increase the data rate of content 542-2 may be generated when the data rate of outgoing content 542-4 exceeds the data rate of incoming content 542-3 by a threshold amount. Alternatively, generation of the request may further depend on amount of buffered content within cached 558, such that the request is more likely to be generated as the amount of cached content decreases. Tracking system 560 may also send a connectivity warning to MWM 546 when the data rate of outgoing content 542-4 exceeds that of incoming content 542-3. Tracking system 560 and/or TWM 548 may generate a request to decrease the data rate of content 542-2 to avoid buffer overflow in a similar fashion.

Network management system 502 may predict that wireless device 510 will roam from AP/POP 514-1 to one or more other APs/POPs 514, and may compute a transition trigger, such as described in one or more examples herein.

Network management system 502 may also control network infrastructure 502 to transmit identical buffered content from AP/POP 514-1 and the predicted destination AP(s)/POP(s) 514, synchronous with one another, during a transition period, such as described in one or more examples herein.

Network management system 502 may provide wireless device 510 with advance notice of a predicted roam, which may include network addresses of predicted destination AP(s)/POP(s) and transition trigger information.

TWM 548 listens for such notice from network management system 522, and may communicate the notice to memory system 556. TWM 548 may store network addresses of predicted destination APs/POPs and/or transition trigger information in memory 558.

Prior to a transition trigger, memory system 556 may provide stored transition trigger information and AP/POP address(es) to TWM 548. Memory system 556 may also provide an indication of stream progress to MWM 546.

During a transition period, wireless device 510 may receive identical content from one or more of AP/POP 514-1 and predicted destination AP(s)/POP(s) such as described further above, without having to negotiate a connection, channel, or session with the corresponding APs/POPs. Wireless device 510 may continue to receive identical content from one or more of AP/POP 514-1 and predicted destination AP(s)/POP(s) throughout the transition period, which may be fixed or variable under control network management system 522, such as described further above.

As disclosed herein, transitions of a wireless device amongst APs/POPs of an external network are determined by a network management system, and controlled by the network management system to provide identical synchronous buffered content to the wireless device from multiple APs/POPs (e.g., with a device-specific ID in a destination address field of the packets), as the wireless device roams within external network, without request from the wireless device, and without additional handshaking or negotiation with the wireless device. The predicted destination APs/POPs thus appear to spontaneously present themselves to the wireless device, as available sources of the buffered content, as the wireless device roams within the external network.

Transition-based wireless system 540 thus permits hot-swapping of wireless device 510 amongst APs/POPs 514, without conventional handshaking and without disruption of streaming content 542-5 to user-interface 544.

Wireless device 510 may be implemented alone or in combination with a network infrastructure and network management system such as described in one or more examples herein.

Methods and systems disclosed herein may be implemented in circuitry, a processor and corresponding instructions, and/or other machine, including discrete and integrated circuitry, an application specific integrated circuit (ASIC), and/or a microcontroller, and may be implemented as part of a domain-specific integrated circuit package or system-on-a-chip (SOC), and/or a combination of integrated circuit packages, and combinations thereof.

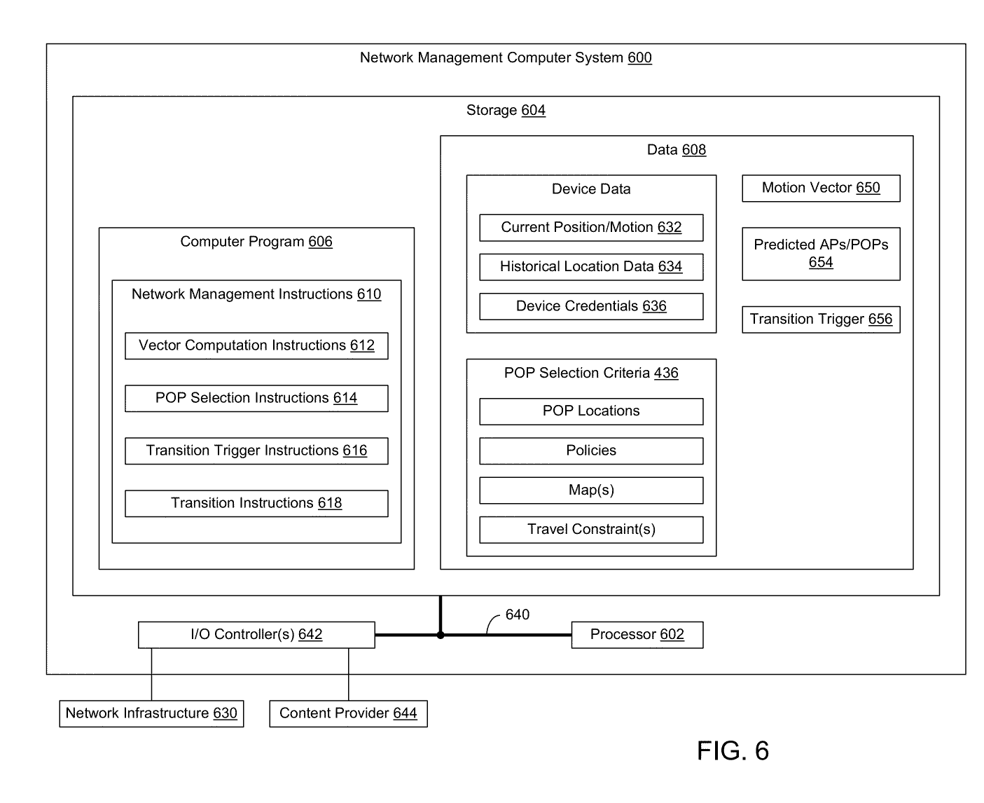

FIG. 6 is a block diagram of a computer system configured as a network management computer system 600 to manage a packet protocol network infrastructure 630. Network infrastructure 630 may be implemented as described in one or more examples above.

Computer system 600 includes one or more instruction processors and/or processor cores, illustrated here as a processor 602, to execute a computer program 606. Processor 602 may include a general purpose instruction processor, a controller, a microcontroller, and/or other instruction-based processor. Computer program 606 may be encoded within a computer-readable medium, which may include a non-transitory computer-readable medium. Computer program 606 may also be referred to as computer program logic and/or software.

Computer system 600 further includes storage 604, illustrated here as including a computer program 606 and data 608 to be used by processor 602 during execution of computer program 606, and/or generated by processor 602 during execution of computer program 606.

Computer program 606 includes network management instructions 610 to cause processor 602 to manage a PP network, such as described in one or more examples above.

In FIG. 6, network management instructions 610 include vector computation instructions 612 to cause processor 602 to compute a motion vector for a mobile wireless device based on current position/motion data 632, historical location data 634, and corresponding time-stamps, such as described in one or more examples above.

Network management instructions 610 further include AP/POP selection instructions 614 to cause processor 602 to predict one or more destination APs/POPs for the wireless device based on motion vector 650 and POP selection criteria 436, such as described in one or more examples above.

Network management instructions 610 further include transition trigger instructions 616 to cause processor 602 to compute a transition trigger 656, such as described in one or more examples above.

Network management instructions 610 further include transition instructions 618 to cause processor 602 to initiate and/or manage transition of the wireless device amongst APs/POPs of network infrastructure 630, such as described in one or more examples above.

Computer system 600 further includes communications infrastructure 640 to communicate amongst devices and/or resources of computer system 600.

Computer system 600 further includes one or more input/output (I/O) devices and/or controllers 642 to communicate with one or more other systems, such as network infrastructure 630 and/or a content provider 644.

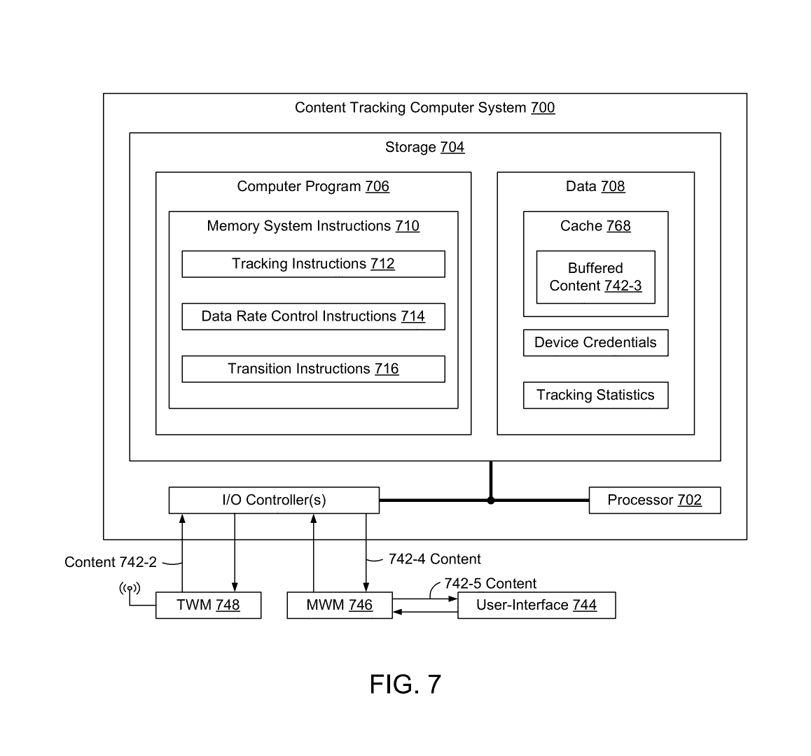

FIG. 7 is a block diagram of a computer system configured as a content tracking system 700 of a wireless device to provide seamless packet-based content 742-5 to a user-interface 744 of the wireless device during transitions amongst APs/POPs of a packet protocol network, including to provide identical synchronous content to the wireless device through multiple APs/POPs during a transition.

Computer system 700 includes a processor 702 to execute a computer program 706. Processor 702 may be implemented as described above with reference to processor 602 in FIG. 6.

Computer program 706 may be encoded within a computer-readable medium as described above with reference to FIG. 6.

Computer system 700 further includes storage 704, illustrated here as including a computer program 706, and data 708 to be used by processor 702 during execution of computer program 706, and/or generated by processor 702 during execution of computer program 706.

In FIG. 7, a portion of storage 708 is configured as cache 768 to buffer content 742-3 from a transient wireless module (TWM) 748, such as described above with reference to content 542-3 in FIG. 5.

Computer program 706 includes memory system instructions 710 to cause processor 702 to manage buffered content 742-3, such as described above with reference to FIG. 6.

Memory system instructions 710 include tracking instructions 712 to cause processor 702 to monitor and/or track incoming content 742-3 from TWM 748, and outgoing content 742-4 to a master wireless module (WMM) 746, such as described above with reference to FIG. 6.

Memory system instructions 710 may include data rate control instructions 714 to cause processor 702 to generate requests to increase or decrease a data rate of incoming content 742-3, such as described above with reference to FIG. 6.

Memory system instructions 710 further include transition instructions 716 to cause processor 702 to manage transition of the mobile wireless device amongst APs/POPs of the network, such as to provide device credentials and/or tracking statistics to TWM 748, MWM 746, and/or to a destination AP/POP, such as described in one or more examples above

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A system, comprising:
network infrastructure to establish a static channel with a content provider based on credentials of a wireless device, receive from the content provider over the static channel, buffer the received content, and provide the buffered content to the mobile wireless device through a first wireless access point (AP);
a vector computation module to estimate a motion trajectory based on a history of locations of the mobile wireless device and corresponding time-stamps; and
a selector to predict one or more destination APs to which the wireless device will roam based on a combination of the motion trajectory, geographic locations of network APs, and one or more travel constraints;
wherein the network infrastructure is configured to provide identical buffered content to the wireless device through the first AP and the one or more predicted destination APs during a transition period, synchronous with one another, and to maintain the static channel with the content provider during the transition period.

2. The system of claim 1, wherein the one or more travel constraints include predetermined permitted travel paths.

3. The system of claim 1, wherein the one or more travel constraints include a speed limit.

4. The system of claim 1, wherein the one or more travel constraints include a traffic condition.

5. The system of claim 1, wherein the history of locations of the mobile wireless device and corresponding time stamps include:
a list of APs with which the wireless device previously connected, and corresponding geographic positions; and
location coordinates received from the wireless device, and corresponding time stamps.

6. The system of claim 1, wherein the selector is configured to:
predict a measure for which the wireless device will be within overlapping wireless coverage areas of the first and second APs; and
determine a transition trigger based on the predicted measure, wherein the transition trigger defines the beginning of the transition period.

7. The system of claim 6, wherein the measure includes a time at which the wireless device is estimated to be within the overlapping coverage areas.

8. The system of claim 6, wherein the measure includes an identification of a data packet within the content received from the content provider, at which the wireless device will be within the overlapping coverage areas.

9. The system of claim 1, wherein:
the network infrastructure includes multiple routers, each to route traffic to one or more associated APs;
wherein each router includes a corresponding set of the vector computation module and the selection module; and
wherein a first router associated with the first AP is configured to provide a router associated with each of the one or more predicted destination APs with credentials of the mobile wireless device and transition period trigger information prior to the transition period.

10. The system of claim 1, wherein the content includes streaming media.

11. A method, comprising:
establishing a static channel between network infrastructure and a content provider based on credentials of a wireless device;
receiving content from the content provider over the static channel, buffering the received content, and providing the buffered content to the mobile wireless device through a first wireless access point (AP);
estimating a motion trajectory based on a history of locations of the mobile wireless device and corresponding time-stamps;
predicting one or more destination APs to which the wireless device will roam based on a combination of the motion trajectory, a geographic location of network APs, and one or more travel constraints;
providing identical buffered content to the wireless device through the first AP and the one or more predicted destination APs during a transition period, synchronous with one another; and
maintaining the static channel with the content provider during the transition period.

12. The method of claim 11, wherein the one or more travel constraints include predetermined permitted travel paths.

13. The method of claim 11, wherein the one or more travel constraints include a speed limit.

14. The method of claim 11, wherein the one or more travel constraints include a traffic condition.

15. The method of claim 11, wherein the history of locations of the mobile wireless device and corresponding time stamps include:
a list of APs with which the wireless device previously connected, and corresponding geographic positions; and
location coordinates received from the wireless device, and corresponding time stamps.

16. The method of claim 11, wherein the predicting includes:
predicting a measure for which the wireless device will be within overlapping wireless coverage areas of the first and second APs; and
determining a transition trigger based on the predicted measure, wherein the transition trigger defines the beginning of the transition period.

17. The method of claim 16, wherein the measure includes a time at which the wireless device is estimated to be within the overlapping coverage areas.

18. The method of claim 16, wherein the measure includes an identification of a data packet within the content received from the content provider, at which the wireless device will be within the overlapping coverage areas.

19. The method of claim 11, further including:
performing the estimating and the predicting at a first router associated with the first AP; and
providing a destination router associated with each of the one or more predicted destination APs with credentials of the mobile wireless device and transition period trigger information, from the first router prior to the transition period.

20. The method of claim 11, wherein the content includes streaming media.

21. A non-transitory computer-readable medium encoded with a computer program, including instructions to cause a processor to:
establish a static channel with a content provider based on credentials of a wireless device;
receive content from the content provider over the static channel, buffer the received content, and provide the buffered content to the mobile wireless device through a first wireless access point (AP);
estimate a motion trajectory based on a history of locations of the mobile wireless device and corresponding time-stamps;
predict one or more destination APs to which the wireless device will roam based on a combination of the motion trajectory, a geographic location of network APs, and one or more travel constraints;
provide identical buffered content to the wireless device through the first AP and the one or more predicted destination APs during a transition period, synchronous with one another; and
maintain the static channel with the content provider during the transition period.

22. The computer-readable medium of claim 21, wherein the one or more travel constraints include predetermined permitted travel paths.

23. The computer-readable medium of claim 21, wherein the one or more travel constraints include a speed limit.

24. The computer-readable medium of claim 21, wherein the one or more travel constraints include a traffic condition.

25. The computer-readable medium of claim 21, wherein the history of locations of the mobile wireless device and corresponding time-stamps include:
a list of APs with which the wireless device previously connected, and corresponding geographic positions; and
location coordinates received from the wireless device, and corresponding time stamps.

26. The computer-readable medium of claim 21, further including instructions to cause the processor to:
predict a measure for which the wireless device will be within overlapping wireless coverage areas of the first and second APs;
determine a transition trigger based on the predicted measure, wherein the transition trigger defines the beginning of the transition period.

27. The computer-readable medium of claim 26, wherein the measure includes a time at which the wireless device is estimated to be within the overlapping coverage areas.

28. The computer-readable medium of claim 26, wherein the measure includes an identification of a data packet within the content received from the content provider, at which the wireless device will be within the overlapping coverage areas.

29. The computer-readable medium of claim 21, wherein the content includes streaming media.
